(19) United States
(12) Patent Application Publication
(10) Pub. No.: US 2026/0220023 A1
(43) Pub. Date: Jul. 30, 2026

(54) SYSTEMS AND METHODS FOR DETERMINING APPLICATION STABILITY IN A DISTRIBUTED COMPUTING ENVIRONMENT

(71) Applicant: BANK OF AMERICA CORPORATION, Charlotte, NC (US)

(72) Inventors: Sebastian Joseph, Jacksonville, FL (US); Bikram Shrestha, Frisco, TX (US); Vijay Kamisetti, Hyderabad, Telangana (IN); Niranjan Nithiyanandam, Chennai, Tamilnadu (IN); Divya Satheesh Nair, Davidson, NC (US)

(73) Assignee: BANK OF AMERICA CORPORATION, Charlotte, NC (US)

(21) Appl. No.: 19/040,246

(22) Filed: Jan. 29, 2025

(51) Int. Cl. G06F 11/3604

(52) U.S. Cl. CPC G06F 11/3612

(57) ABSTRACT

Systems, computer program products, and methods are described herein for determining application stability in a distributed computing environment. The present disclosure is configured to determine application stability dimensions associated with an application which may include technical deficits, small file percentages, file count limits, or production incidents. Application data corresponding to each of the application stability dimensions may be retrieved. A stability value may be computed for an application based on the application data. The stability value may be provided to a user device associated with a user managing the application.

### TECHNOLOGICAL FIELD

Example embodiments of the present disclosure relate to systems and methods for determining application stability in a distributed computing environment.

### BACKGROUND

There are significant issues associated with determining application stability. Applicant has identified a number of deficiencies and problems associated with conventional solutions for determining an application's stability. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for determining application stability in a distributed computing environment.

Embodiments of the present invention address the above needs and/or achieve other advantages by providing apparatuses (e.g., a system, computer program product, and/or other devices) and methods for determining application stability in a distributed computing environment. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the solutions as described herein may determine a plurality of application stability dimensions associated with an application in a distributed computing environment including at least one of technical deficits, small file percentages, file count limits, or production incidents. In some embodiments, the solutions may retrieve application data corresponding to each of the plurality of application stability dimensions. In some embodiments, the solutions may compute a stability value for the application based on the retrieved application data. In some embodiments, the solutions may provide the stability value to a user device of a user managing the application.

In some embodiments, the solutions may reduce the stability value if a total file count exceeds the file count limit, or if the total file count is below the file count limit and at least one production incident includes a small file flag.

In some embodiments, the solutions may generate at least one visual dashboard including the stability value, each respective dimension's contribution, and any applied reduction.

In some embodiments, the solutions may periodically re-compute the stability value associated with the application. In some embodiments, the solutions may determine, based on the re-computed stability values, long-term trends of the application's stability.

In some embodiments, the solutions may determine one or more remediation actions based on the stability value being below a threshold stability value.

In some embodiments, the technical deficits may further include at least one of an application issue impacting performance of the application, an operational inefficiency, or a violation of a standard operating procedure.

In some embodiments, the technical deficits may be defined by a severity level, wherein the severity level includes at least one of a high severity level, a medium severity level, or a low severity level.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining application stability in a distributed computing environment, in accordance with an embodiment of the disclosure;

FIG. 2 illustrates a process flow for determining application stability in a distributed computing environment, in accordance with an embodiment of the disclosure; and

FIG. 3 illustrates an example diagram of one or more end-point devices and associated applications in a distributed computing environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The technology as described herein relate to an application stability determination system operating in a distributed computing environment. The disclosure as provided herein may use various data sources to quantify and evaluate the stability or health of an application. Specifically, the system may collect metrics (e.g., dimensions) such as technical deficits, small file percentages, file count limits, and production incidents and synthesize these inputs to generate a unified measure of an application's stability.

In conventional distributed computing environments, challenges surround precisely assessing and managing the health of individual applications. Further, the scale of conventional systems, especially when vast quantities of files, configurations, and the like are involved, create significant difficulties in identifying performance issues with the applications. There exists issues relating to visibility into critical metrics which typically result in suboptimal resource allocation, unexpected downtimes, and delayed remediation of underlying issues with current systems. In this way, the traditional systems may provide inadequate information to stakeholders using the information to make decisions regarding maintenance, improvement, or the like of the applications.

To address the concerns, an application stability determination system is introduced. In some embodiments, the solutions as described herein compile relevant stability metrics associated with an application and determine their collective impact on an application's stability. By consolidating data related to technical deficits, file management, and production incidents, the solutions as described herein may determine a single stability value that reflects the real-time state of the application.

What is more, the present disclosure provides a technical solution to a technical problem. As described herein, the technical problem includes the inability for conventional systems to holistically and accurately determine the stability of an application within a distributed computing environment. The technical solution presented herein allows for the automated and efficient calculation of an application stability value, derived from retrieving, processing, and analyzing multiple dimensions of an application in single, streamlined operation. In particular, the application stability determination system (e.g., the system 130 as described herein) is an improvement over existing solutions to the above-described problem, (i) with fewer steps to achieve the solution, thus reducing the amount of computing resources, such as processing resources, storage resources, network resources, and/or the like, that are being used (e.g., by eliminating redundant data retrieval tasks), (ii) providing a more accurate solution to problem, thus reducing the number of resources required to remedy any errors made due to a less accurate solution (e.g., avoiding costly re-analysis or misguided remediation actions), (iii) removing manual input and waste from the implementation of the solution, thus improving speed and efficiency of the process and conserving computing resources (e.g., by automating the correlation of stability dimensions previously done manually), (iv) determining an optimal amount of resources that need to be used to implement the solution, thus reducing network traffic and load on existing computing resources (e.g., by dynamically adjusting computation frequency based on current application conditions). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the application stability determination system as described herein is a solution to the problem of obtaining a comprehensive, stability value for an application in a distributed computing environment without expending unnecessary computing resources. Further, the application stability determination system may be characterized as identifying a specific improvement in computer capabilities and/or network functionalities in response to the application stability determination system's integration to existing devices, software, applications, and/or the like. In this way, the application stability determination system improves the capability of a system to accurately and efficiently determine an application's stability value, while reducing complexity and manual intervention. Further, the application stability determination system improves the functionality of networks in response to reducing the resources consumed by the system (e.g., network resources, computing resources, memory resources, and/or the like).

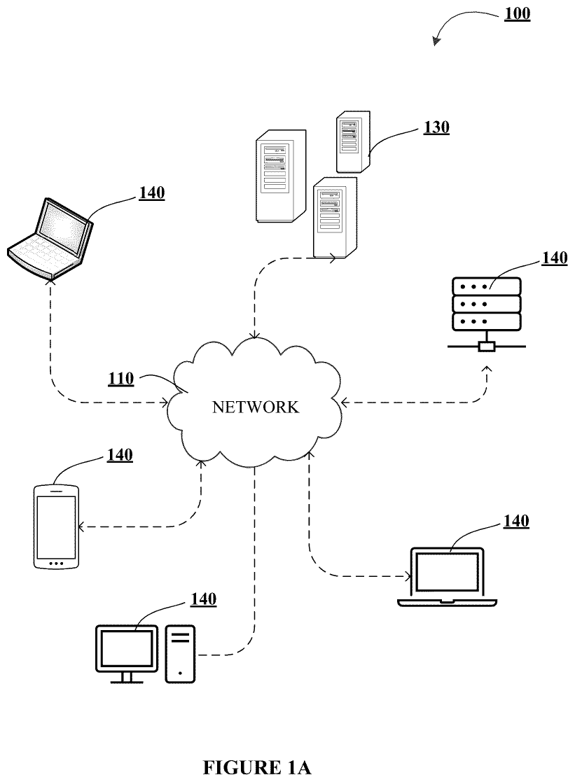

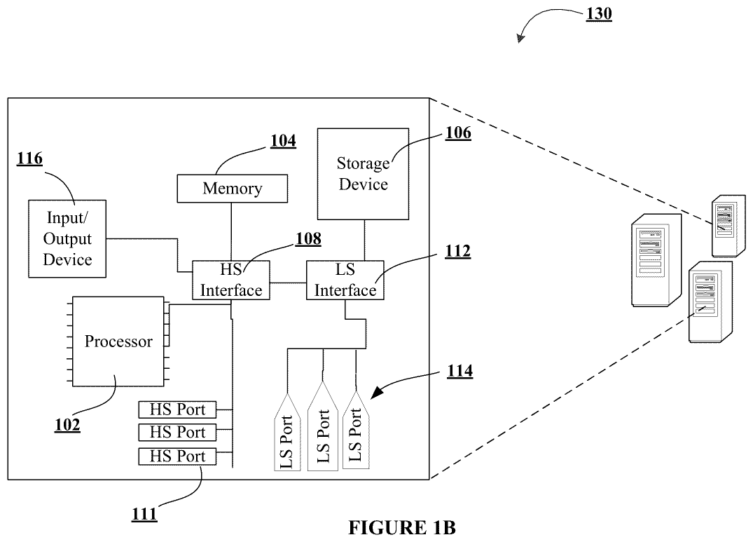

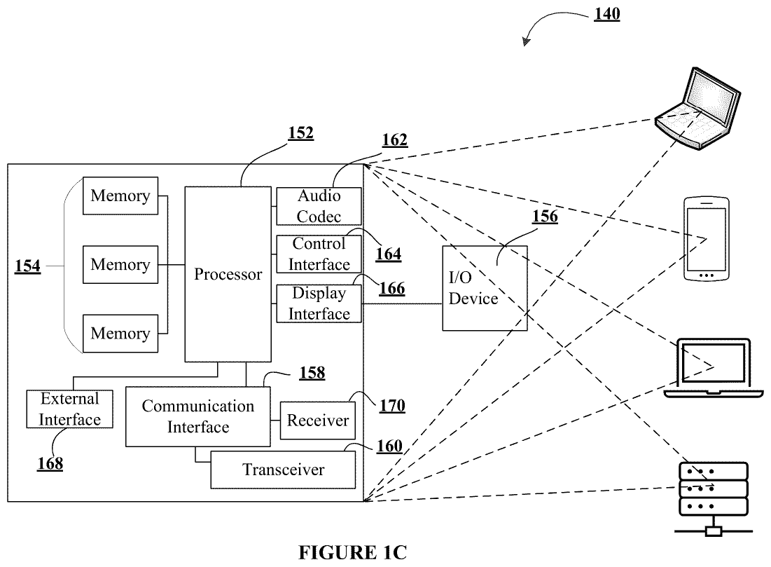

FIGS. 1A-1C illustrate technical components of an exemplary distributed computing environment 100 for determining application stability in a distributed computing environment, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Further, in some embodiments, the system 130 and the end-point device(s) 140 may have a client-server relationship. In some embodiments, the system 130 may represent various forms of servers, such as web servers, database servers, and file servers that together form a distributed computing system.

In some embodiments, the end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

In some embodiments, the network 110 may be a distributed network that is spread over different networks which may support distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 and/or multiple systems (same or similar to system 130) may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information. In another implementation, the memory 104 is a non-volatile memory unit or units (e.g., EEPROM, flash memory, or the like) that may be read during execution of computer instructions. The memory 104 may also be another form of computer-readable medium, such as a magnetic or optical disk, which may be embedded and/or may be removable. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. The computer program product may also contain instructions that, when executed, perform one or more methods, such as those described above.

In some embodiments, the system 130 may be configured to access, via the network 110, a number of other computing devices (not shown). In this regard, the system 130 may be configured to access and/or dynamically configure one or more storage devices and/or one or more memory devices associated with each of the other computing devices. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication (e.g., wired or wireless) of end-point device(s) 140 with other devices.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store and/or secure applications or other information therein. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

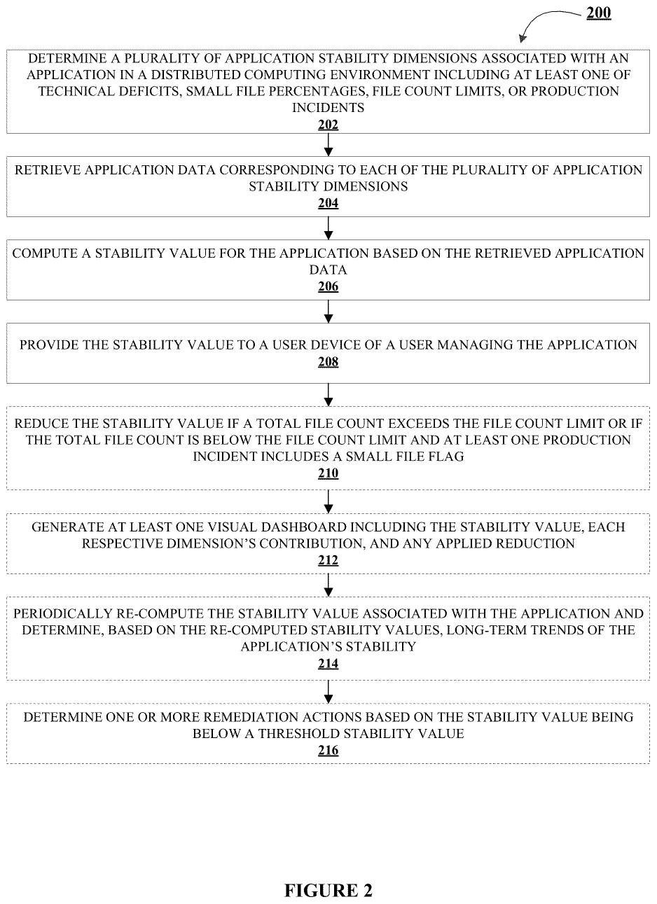

FIG. 2 illustrates a process flow for determining application stability in a distributed computing environment, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

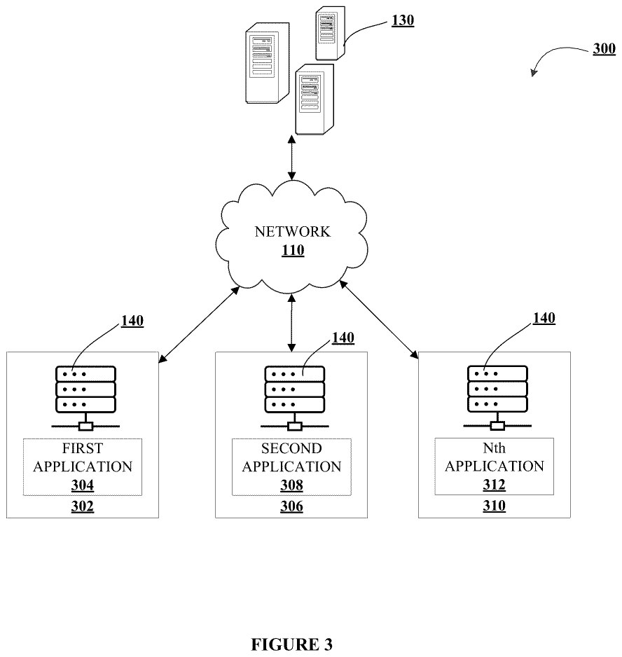

In some embodiments, an application stability determination system (e.g., similar to one or more of the systems described herein with respect to FIGS. 1A-1C) may perform one or more of the steps of process flow 200. For example, an application stability determination system (e.g., the system 130 described herein with respect to FIGS. 1A-1C) may perform the steps of process flow 200. In some embodiments, and as shown in FIG. 3, the system 130 may communicate, via a network 110, to one or more end-point devices 140 and/or one or more applications associated with those end-point devices 140. For example, the system 130 may communicate with a first end-point device 302 which may include a first application 304, a second end-point device 306 which may include a second application 308, or an Nth end-point device 310 which may include an Nth application 312. In some embodiments, an end-point device 140 may include on or more applications. In some embodiments, an application may be associated with one or more end-point device 140.

As shown in block 202, the process flow 200 of this embodiment includes determining a plurality of application stability dimensions associated with an application in a distributed computing environment including at least one of technical deficits, small file percentages, file count limits, or production incidents. In some embodiments, the stability of an application may relate to the application's integrity, performance, or the like that indicates the overall health of the application. In this way, the application's stability may measure how well the application performs during operation, which may include the application's issue-free sessions or an amount of sessions that did not include an error. In some embodiments, each of the dimensions (e.g., stability dimensions) may play a role in influencing the overall stability of an application. For example, the technical deficits may include issues such as software bugs, architectural inefficiencies, or deviations from best practices that, if unaddressed, may degrade application performance over time.

Further, in some embodiments, the small file percentages may affect storage and processing overhead in systems or applications, leading to inefficiencies in resource management and potential bottlenecks. In some embodiments, the small file percentage may include a percentage of the total files that are smaller than a specified size. For example, the small file percentage may include the percentage of files that are small than 64 megabytes (MB) as compared to the total files of that particular application.

Further, in some embodiments, the file count limit may include a comparison of an application's file count to the assigned file count limit. In some embodiments, the file count limit adherence may be derived from the application's allocated space (e.g., memory) quota. Further, exceeding the file count limit dimension may trigger operation or performance challenges, such as longer load times, increased maintenance, and/or higher instances of data corruption and/or application failures.

Further, in some embodiments, the production incidents may capture real-world failures or errors (e.g., outages or service degradations) that directly impact end-user experiences and may signal deeper underlying issues in the application.

In some embodiments, the technical deficits may include at least one of an application issue impacting the performance of the application, an operational inefficiency, or a violation of a standard operating procedure. Further, these different categories of technical deficits can arise from various underlying causes. For instance, an application issue impacting performance may involve excessive processing times, increased memory usage, or unexpected application crashes or outages. In some embodiments, an operational inefficiency may include redundant processes or unnecessary resource allocations that may lead to slow execution or high operational costs. Meanwhile, in some embodiments, a violation of a standard operating procedure may involve failing to adhere to guidelines (e.g., internal or external guidelines) for data storage, version control, system monitoring, or the like.

In some embodiments, the technical deficits may influence the performance of the application in both known and unknown ways. For example, an underlying issue may remain undetected until the application(s) reach a high level of concurrent usage, suddenly triggering performance degradation or service interruptions. Additionally, or alternatively, the existence of an obscure defect may only become apparent under specific conditions (e.g., peak load scenarios, configuration changes, new data format introductions, or the like), making it difficult to pinpoint until failures arise. Further, the technical deficits may also be discovered during various stages of the application lifecycle, including in-depth testing, beta releases, or full production operations. In this way, the detection of a technical deficit may arise from deficits being unaccounted for during initial development of the application which underscores the importance of thorough monitoring, logging, and diagnostic tools, such as the solutions described herein.

In some embodiments, the technical deficits may be defined by a severity level, wherein the severity level may include at least one of a high severity level, a medium severity level, or a low severity level. In some embodiments, the assignment of severity levels to the technical deficits may allow the system, along with stakeholders and/or users, to triage and prioritize remediation efforts. In some embodiments, a high severity deficit may indicate a critical defect with the potential to cause significant downtime or data loss if unaddressed. In other embodiments, a medium severity level may include an issue that could degrade performance or user experience but does not pose an immediate issue to the system's stability or data integrity. Further, in some embodiments, a low severity level may include minor inefficiencies or cosmetic bugs that, while potentially affecting user experience, do not impede the application's core functionality.

In some embodiments, the categorization of the technical deficits into the severity levels may allow development teams to direct resources to the most urgent or impactful issues first. Further, this approach may help maintain system stability and performance as well as providing clear framework for communicating issues and remedies. In some embodiments, over time, tracking trends in these severity levels may further help an organization (e.g., an organization hosting an application or the system 130 as described herein) whether the technical deficits are increasing or decreasing. In this way, the trend detection may include assisting decisioning based on application maintenance, upgrades, elimination, depreciation, or the like.

As shown in block 204, the process flow 200 of this embodiment includes retrieving application data corresponding to each of the plurality of application stability dimensions. In some embodiments, the application data may be collected from a variety of sources, such as performance logs, configuration databases, monitoring services, incident reports, user feedback channels, or the like. The data sources may be accessed periodically or in real time, depending on the specific needs and operating functions of the distributed computing environment. Further, by gathering data across multiple sources and across multiple dimensions (e.g., technical deficits, small file percentages, file count limits, production incidents, etc.), the system 130 may construct a more complete an accurate assessment of the application's overall state or stability. In some embodiments, this may enable the system to identify potential issues early, detect trends in application performance, and account for specific contextual information that may otherwise be overlooked. Further, in some embodiments, centralizing the information in the system 130 allows for streamlined analytics, correlation computation, and reporting, ultimately leading to more reliable stability value analysis and targeted remediation efforts.

As shown in block 206, the process flow 200 of this embodiment includes computing a stability value for the application based on the retrieved application data. In some embodiments, the computation of the stability value may involve aggregating, normalizing, or the like, the individual metrics associated with each stability dimension. For example, the computation may include using the technical deficit information, the percentage of small files, the total file count, and the frequency and/or severity of the production incidents. Further, in some embodiments, the stability value may include a single, unified score or value that uses the information retrieved from the one or more dimensions. In some embodiments, the system 130 may use one or more algorithms, which may be tailored to account for varying scales or formats of the incoming data. For example, the system 130 may transform raw metrics of the technical deficits into standardized numerical values. In this example, the system 130 may weigh or tank the values according to predefined or, in some embodiments, dynamically adjusted criteria, and combine them to generate a cohesive stability value. Further, in some embodiments, the stability value may ensure disparate types of data may be meaningfully compared and/or correlated to provide efficient and effective analysis.

Additionally, or alternatively, in some embodiments, the computation process may apply certain rules or thresholds, such as one or more stability value reductions for exceeding preset file count limits or for incidents flagged with small file issues. In some embodiments, such rules not only refined the resulting value but also provide deeper insight into the specific areas requiring attention. Further, in some embodiments, the centralization of all relevant metrics into one value allows for simple decision making. For example, a stakeholder making a decision surrounding a particular application based on the application's stability may use the relative stability metrics as discussed herein to make the decision rather than analyzing complex or uncorrelated metrics. Further, in some embodiments, the computation process may include historical stability values where appropriate to enable trend analysis that may highlight whether the application's stability is improving or degrading over a period of time.

In some embodiments, the stability value may be calculated by combining the one or more dimension values. In some embodiments, this may include using the values of an application's small file percentage dimension value, file count limit dimension value, technical deficit dimension value, incident dimension value, etc. In some embodiments, a weighting factor may be applied to the dimension values to generate a weighted dimension value.

As shown in block 208, the process flow 200 of this embodiment includes providing the stability value to a user device of a user managing the application. In some embodiments, the stability value may be displayed via an interactive dashboard, an automated notification, or the like. Further, providing the stability value to the user device may allow the user to be informed of the application's stability in real-time or near real-time. In some embodiments, the user may be able to make informed decisions because the user may receive the analysis performed by the system 130.

As shown in block 210, the process flow 200 of this embodiment may include reducing the stability value if a total file count exceeds the file count limit or if the total file count is below the file count limit and at least one production incident includes a small file flag. In some embodiments, the reduction may serve as a mechanism designed to highlight serious issues related to the file management within an application. For example, by automatically detecting when the application surpasses a present threshold for its total file count, the system 130 may apply a proportional decrement to the stability value, which may reflect the increased likelihood of application issues such as performance bottlenecks, resource constraints, and/or operational complications. Further, in some embodiments, even if the file count remains within acceptable bounds, the small file flag in a production incident may indicate a separate, significant concern (e.g., that an excessive number of small files may be causing similar inefficiencies or issues).

Further, in some embodiments, the system 130 may detect the source of degradations associated with the application and provide in-depth analysis of the application's stability. In this way, the reduction in the stability value provides information to the system 130 and to stakeholders and/or users for them to determine the severity of issues associated with the application, which may allow them to make timely remediation efforts. Further, in some embodiments, the reduction being based on the quantifiable triggers (e.g., exceeding file count limits or encountering small files), the system may ensure consistency and objectivity in the analysis of the application's stability. Further, in some embodiments, the reductions in the application's stability may be used for long-term trend analysis to determine whether corrective measures are needed to improve the application's stability (e.g., refactoring file structures and/or optimizing storage settings).

As shown in block 212, the process flow 200 of this embodiment may include generating at least one visual dashboard including the stability value, each respective dimension's contribution, and any applied reduction. In some embodiments, the dashboard may serve as a centralized interface through which stakeholders (e.g., system administrators, developers, product owners, etc.) may review and interpret the stability of the applications and/or systems. In some embodiments, the dashboard may feature a variety of graphical elements such as charts, scorecards, or other visual indicators that may detail how each dimension affects the overall application stability value. In some embodiments, the applied reduction from specific triggers, such as exceeding a file count limit or encountering a small file flag, may be displayed to underscore critical issues and promote prioritization of correcting the issue.

Further, in some embodiments, the dashboard may be used to present historical trends, which may include whether the stability value has improved or deteriorated over time. Further, in some embodiments, the historical trends may offer insights into recurring issues or progress made for remediation efforts. In some embodiments, the visual representations may be tailored to various user roles, providing detailed breakdowns for technical teams while presenting high-level summaries for stakeholders such as executives, directors, or non-technical stakeholders. In doing so, the visual dashboard may streamline access to crucial data and also enhance collaboration as users may discuss and prioritize the actions for remediation in order to improve the application's stability.

As shown in block 214, the process flow 200 of this embodiment may include periodically re-computing the stability value associated with the application and determining, based on the re-computed stability values, long-term trends of the application's stability. In some embodiments, the re-computation may occur at specified intervals (e.g., hourly, daily, weekly, monthly, yearly, etc.), depending on the nature and criticality of the application. Additionally, or alternatively, in some embodiments, the system may trigger a recalculation event when key application metrics, such as the one or more dimensions, exceed predefined thresholds. In some embodiments, by continuously updating the stability value, the system 130 may provide real-time or near real-time insights and analysis into how recent changes, deployments, or environmental conditions may affect the application's performance and stability.

Further, in some embodiments, tracking the re-computed values over extended periods may enable the system 130 to detect emerging patterns and/or trends. For example, if the stability value consistently declines follow each major release, stakeholders may investigate potential regressions in code quality, infrastructure changes, or the like that may be contributing to the issues surrounding the application's stability. In this regard, periodic re-computation may maintain accurate and up-to-date views of the application's stability and also inform strategic decision-making regarding resource allocation, technical deficit management, and system upgrades. Further, in some embodiments, the continuous feedback loop may promote proactive monitoring and maintenance of application stability, which may reduce the likelihood of sudden and/or unforeseen performance issues in distributed computing environments.

As shown in block 216, the process flow 200 of this embodiment may include determining one or more remediation actions based on the stability value being below a threshold stability value. In some embodiments, the threshold stability value may represent a baseline level of health or performance that is acceptable for the application. In some embodiments, when the computed stability value falls below the threshold, it may signal at least one aspect of the application's operations or functions (e.g., technical deficits, file usage, incident management, or the like), requires attention.

Further, in some embodiments, the system 130 may automatically identify or recommend specific remediation actions. For example, the actions may involve prioritizing and fixing high-severity technical deficits, reallocating resources to address performance bottlenecks, modifying file count limits to reduce overhead, cleaning or reformatting application file databases, addressing small file flags that may create inefficiencies, or the like. In some embodiments, the system may link remediation efforts to the application's stability value which may ensure corrective measures target the issues that require the most attention. Further, in some embodiments, the system 130 may notify the responsible stakeholders (e.g., via a notification to a user device, as described herein), so the stakeholders may implement or approve suggested remediations.

In some embodiments, the present disclosure may use an artificial intelligence (AI) engine to dynamically adjust or refine the one or more weights applied to the dimension values. In this way, the AI engine may ingest real-world data and conditions and configure or reconfigure the weight values applied to the dimensions. For example, the AI engine may analyze historical data to correlate past stability scores with real-world incidents, which may allow the system to identify which dimensions most directly impact application stability and adjust the weights accordingly. Additionally, or alternatively, in some embodiments, predictive models (e.g., regression algorithms, neural networks, etc.) may be trained on historical application metrics to forecast performance, bottlenecks, and/or failures, which may be used to guide the AI engine to adjust the weights to optimize accuracy of determining application stability.

In some embodiments, adaptive feedback loops may be used to refine the weights in real time (or near real time). In some embodiments, each time the system calculates a new stability score, the observed outcomes in production (e.g., incident frequency, user complaints, etc.) may be used to inform the accuracy of the determination mechanism, which may prompt incremental recalibration when discrepancies occur. Further, in some embodiments, context-aware factors, such as peak usage times, may further drive instantaneous weight adjustments to reflect changing operational realities. Further, in some embodiments, the AI engine may use clustering and anomaly detection techniques to discover patterns among similar applications, adjusting weights for certain dimensions if evidence suggests one or more factors (e.g., small file percentages) consistently correlate with critical incidents.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining application stability in a distributed computing environment, the system comprising:
a processing device;
a non-transitory storage device containing instructions when executed by the processing device, causes the processing device to perform the steps of:
determine a plurality of application stability dimensions associated with an application in a distributed computing environment comprising at least one of technical deficits, small file percentages, file count limits, or production incidents;
retrieve application data corresponding to each of the plurality of application stability dimensions;
compute a stability value for the application based on the retrieved application data; and
provide the stability value to a user device of a user managing the application.

2. The system of claim 1, wherein executing the instructions further causes the processing device to reduce the stability value if:
a total file count exceeds the file count limit; or
the total file count is below the file count limit and at least one production incident includes a small file flag.

3. The system of claim 1, wherein executing the instructions further causes the processing device to generate at least one visual dashboard comprising the stability value, each respective dimension's contribution, and any applied reduction.

4. The system of claim 1, wherein executing the instructions further causes the processing device to:
periodically re-compute the stability value associated with the application; and
determine, based on the re-computed stability values, long-term trends of the application's stability.

5. The system of claim 1, wherein executing the instructions further causes the processing device to determine one or more remediation actions based on the stability value being below a threshold stability value.

6. The system of claim 1, wherein the technical deficits further comprise at least one of:
an application issue impacting performance of the application;
an operational inefficiency; or
a violation of a standard operating procedure.

7. The system of claim 1, wherein the technical deficits are defined by a severity level, wherein the severity level comprises at least one of:
a high severity level;
a medium severity level; or
a low severity level.

8. A computer program product for determining application stability in a distributed computing environment, the computer program product comprising a non-transitory computer-readable medium comprising code causing an apparatus to:
determine a plurality of application stability dimensions associated with an application in a distributed computing environment comprising at least one of technical deficits, small file percentages, file count limits, or production incidents;
retrieve application data corresponding to each of the plurality of application dimensions;
compute a stability value for the application based on the retrieved application data; and
provide the stability value to a user device of a user managing the application.

9. The computer program product of claim 8, wherein the code further causes the apparatus to reduce the stability value if:
a total file count exceeds the file count limit; or
the total file count is below the file count limit and at least one production incident includes a small file flag.

10. The computer program product of claim 8, wherein the code further causes the apparatus to generate at least one visual dashboard comprising the stability value, each respective dimension's contribution, and any applied reduction.

11. The computer program product of claim 8, wherein the code further causes the apparatus to:
periodically re-compute the stability value associated with the application; and
determine, based on the re-computed stability values, long-term trends of the application's stability.

12. The computer program product of claim 8, wherein the code further causes the apparatus to determine one or more remediation actions based on the stability value being below a threshold stability value.

13. The computer program product of claim 8, wherein the technical deficits further comprise at least one of:
an application issue impacting performance of the application;
an operational inefficiency; or
a violation of a standard operation procedure.

14. The computer program product of claim 8, wherein the technical deficits are defined by a severity level, wherein the severity level comprises at least one of:
a high severity level;
a medium severity level; or
a low severity level.

15. A method of determining application stability in a distributed computing environment, the method comprising:
determining a plurality of application stability dimensions associated with an application in a distributed computing environment comprising at least one of technical deficits, small file percentages, file count limits, or production incidents;
retrieving application data corresponding to each of the plurality of application stability dimensions;
computing a stability value for the application based on the retrieved application data; and
providing the stability value to a user device of a user managing the application.

16. The method of claim 15, wherein the method further comprises reducing the stability value if:
a total file count exceeds the file count limit; or
the total file count is below the file count limit and at least one production incident includes a small file flag.

17. The method of claim 15, wherein the method further comprises generating at least one visual dashboard comprising the stability value, each respective dimension's contribution, and any applied reduction.

18. The method of claim 15, wherein the method further comprises:
periodically re-computing the stability value associated with the application; and
determining, based on the re-computed stability values, long-term trends of the application's stability.

19. The method of claim 15, wherein the method further comprises determining one or more remediation actions based on the stability value being below a threshold stability value.

20. The method of claim 15, wherein the technical deficits further comprise at least one of:
an application issue impacting performance of the application;
an operational inefficiency; or
a violation of a standard operating procedure.
